(19) United States
(12) Patent Application Publication
(10) Pub. No.: US 2014/0310780 A1
(43) Pub. Date: Oct. 16, 2014

(54) COMMUNICATION SYSTEM

(71) Applicant: Dominic Siwik, South Lyon, MI (US)

(72) Inventor: Dominic Siwik, South Lyon, MI (US)

(21) Appl. No.: 14/251,437

(22) Filed: Apr. 11, 2014

Related U.S. Application Data
(60) Provisional application No. 61/810,893, filed on Apr. 11, 2013.

(51) Int. Cl. H04L 29/06

(52) U.S. Cl. CPC H04L 63/08
USPC 726/4

(57) ABSTRACT

A system may include a computing device configured to receive a selection of an electronic item and receive a selection of a recipient. The computing device may associate at least one security option with the electronic item. The computing device may transmit the electronic item and the associated security option to a recipient device associated with the recipient.

### CROSS REFERENCE TO RELATED APPLICATIONS

This application claims priority to U.S. Provisional Patent Application No. 61/810,893 filed Apr. 11, 2013, the contents of which are hereby incorporated in their entirety.

### BACKGROUND

Individuals such as users of computing devices such as mobile phones, so-called smart based hand held devices, tablets and personal computers use a number of systems to facilitate the sending and receiving instant electronic content, such as text or photographic images. For example, individuals may take a photograph of a scene and send it via email or Multimedia Messaging Service (MMS). They may also send real-time communications using variations of Short Message Service (SMS) or by electronic mail. However, such communication methods have limitations that provide an inadequately secure mechanism to facilitate the transmission from a sender to a recipient. Nor do these systems include additional security measures to protect against unauthorized use and viewing. Accordingly, a better system for private and secure communication of electronic content is needed.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 illustrates an exemplary system diagram of an illustrative communication system;

FIG. 2 is an exemplary user interface of the system according to FIG. 1 that might be applicable to either a sender or a recipient;

FIG. 3 is an exemplary flow chart of a process of selecting at least one of an electronic item and a security option to be communicated to a recipient; and

FIG. 4 is an exemplary flow chart illustrating an exemplary processing operation associated with the illustrative system of FIG. 1.

### DETAILED DESCRIPTION

A communication system know under the trademark of GiGi (Get it? Got it! Gone . . . ) allows users to securely communicate with and share a variety of file types with other users. The type of communication, and lifespan of its content, is determined solely by the sender as all files introduced to the “environment” of the communication system are first delivered to proprietary, encrypted servers as illustrated below, before they are made available for use. And once the user deletes the communication, all content is permanently removed from the servers, rendering it irretrievable. Thus, the communication system allows users to “privately” communicate with and share a variety of file types with other users. The type of communication, and lifespan of its content, is determined solely by the sender as all files introduced to the “Environment” of the communication system are first delivered to the proprietary servers before they are made available for use. Therefore, once the user deletes the communication, all content is permanently removed from the “servers” and phone/desktop, rendering it irretrievable, thereby ensuring your utmost privacy. Within the “Environment” of the illustrative communication system such as a portal that encompasses a wide range of computing devices such as an iOS device, an Android device, or Personal Computer users securely and privately communicate via text messaging, email, video, picture sharing, voice mail, file sharing (e.g., Microsoft Office, PDF, QuickTime, MP3), etc. Additionally, the “control” solely exists with the sender; the recipient is unable to save or forward the sender's text, email, pic, video, voice mail unless authorized by the sender as part of the transmission, as the sender dictates the life span and levels of control applicable to a recipient of all communications (contrary to traditional mediums), ensuring the sender's ultimate privacy and “control.”

Features directed to the illustrative communication system may include, but are not limited to the following:

An “environment” may include, for example, an app (created for both iOS and Android devices) that interacts with a Web Based portal, allowing users access to files that currently exist on their computing device or another device associated with that user such as a personal computer. Within this “environment” users can send secure text messages, PDF files, movie files, MP3 files, Microsoft Office documents (Word and Excel), and email and can control the access of the receiver/intended recipient in terms of the length of the message's availability as well as level of the receiver's interaction with the data being sent (for example, the sender has the ability to determine whether or not the receiver can download the sent file to their computer or just view it on their phone).

A streamlined user interface that is both intuitive and functional. The interface incorporates modern “workspace” layouts allowing users to access their contact base, create groups, and communicate more quickly, whether it be through traditional text, file sharing, or voice notifications (Gi-VM) on both their Android and iPhone devices.

The user interface may enable a user to select an electronic item, e.g., an electronic message, live photograph, document, PDF, MP3, JPEG, live video and/or audio recording, and transmit the electronic item to a computing device or server system via an electronic user device. The server system may maintain or otherwise store the communicated electronic item for a defined duration in a database, in which the user and/or recipient may gain access the stored electronic item. Additionally, the user interface may be operable to access historical content maintained locally in the user device. For instance, the user may access his/her camera roll stored on a user device, select a desired photograph or video, and communicate the selected item to a recipient device. As another example, the user may access content maintained locally on a personal or laptop computer, select the content as the electronic item and communicate the item to a designated recipient.

One or more computing devices in the form of at least one central server system may maintain the communicated electronic item for a predetermined retention time selected by the sender-based user device. Accordingly, the central server may include one or more processors, a memory such as a flash memory or a random access memory (RAM), a database integral to or separately disposed with respect to the at least one central server and a telecommunications system that may comprise one or more communications networks associated at least with a sender device, a recipient device and the at least one central server, for example. The central server system may enable the recipient device to access the stored or maintained electronic item, via an associated database, for the length of the retention time, or until the electronic item has otherwise been deleted. According to one example, all processing within the “environment” is performed via a computing device such as central server system. Consequently, the user device and recipient device may facilitate communication via the central server system.

Further, the user may have the ability to select at least one security option that may be associated with the electronic item. For example, a proposed sender via the sender's computing device may instantly delete messages (e.g., text/video messages, email or document transmission, MP3, etc.) via a retraction mechanism, on all computing devices associated with the message (including any recipient computing device) despite the time otherwise left on the life-span of the electronic item that has been previously communicated (e.g., designated retention time), and regardless of whether the recipient has viewed the message/electronic item. That is, a sender may recapture the content communicated to at least one recipient(s) unilaterally and thereby delete any message previously delivered to and resident on a recipients' device, as well as the sender's device and the central server system. Consequently, a sender retains “full” control of all electronic items that form one or more communications between at least two computing devices with the central server system disposed therebetween.

Additionally, the illustrative communication system may include a destruction mechanism. This is a feature that allows the sender to limit the text/email/pic/video/voicemail exposure of any electronic item to a predetermined time period, such as twelve (12) seconds, twenty-four (24) seconds (or other combinations of seconds, minutes, hours or days), for example, via a “time-bomb count-down.” Accordingly, the content communicated to a recipient by a sender may include a timer in which the previously communicated content may be viewed or accessed by the recipient and upon expiration the content irretrievably terminates. In one illustrative approach the content may be viewed as many times as desired during the pre-determined time period.

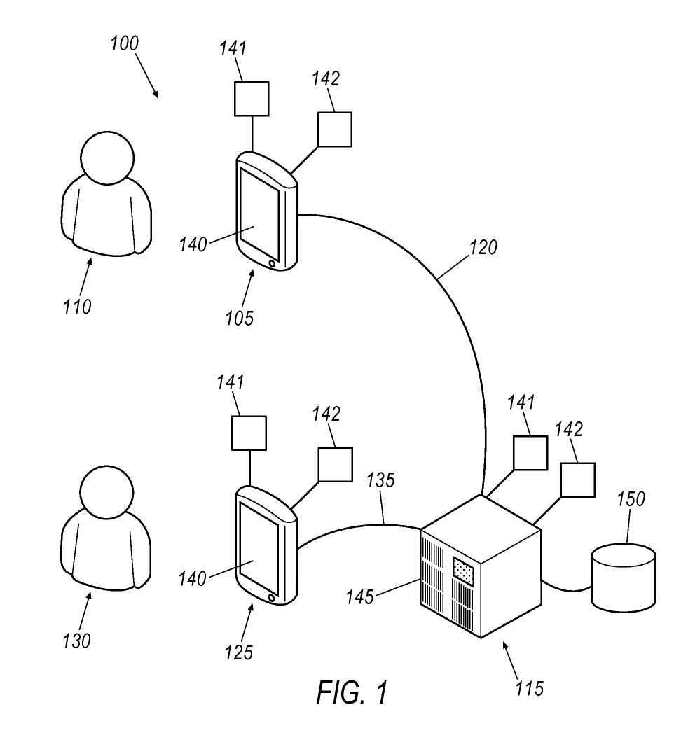

FIG. 1 illustrates an exemplary system 100 including one or more user computing devices 105 (arbitrarily called a sender device) associated with a user 110 in communication with a central server system 115 via at least one communication network 120. The system 100 may also include at least one additional user computing device 125 (arbitrarily called a recipient device) associated with a recipient 130 in communication with the central server system 115 via a second communication network 135. Communication network 120 and communication network 135 may be the same of disparate communication networks. Moreover, two-way communications may be sent between computing devices 105 and 125 so the indication of a “sender” and a “recipient” is arbitrary and selected merely to facilitate discussion.

The computing devices 105 and 125 may include any electronic device, including but not limited to a cellular phone, smart phone, tablet computer, e-reader, personal computer, MP3 device, etc. The computing device 105 includes a user interface 140 such as a graphical user interface (GUI), as explained in more detail below. The computing devices 105 and 125 may be capable of facilitating communications such as voice calls, text messaging, video and photographic transmission, internet access, etc. The user 110 may include a plurality of computing devices 105 while the user 125 may include a plurality of computing devices 125 that each interact with the communication system 100; for example, a mobile phone, tablet, and personal computer may each independently access the system.

The user devices 105 and 125 may include a user interface 140 and a processor 141 with a memory 142. The processor 141 may be configured to execute computer-readable instructions. The processor 141 may be configured to select an electronic message in response to input received from the user interface 140. The user interface 140 may include a single type display (e.g., a touch-screen), or multiple display types (e.g., audio and video) configured for human-machine interaction. The user interface 140 may be operable to receive inputs from a user 110 or a user 130. The user interface 140 may include, for example, control buttons and/or control buttons displayed on a touch-screen display (e.g., hard buttons and/or soft buttons) which enable the user to enter commands and information. Inputs provided to the user interface 140 may be communicated to the processor 141 to control and select various aspects of the system 100. For instance, inputs provided by the user interface 140 may be used by the processor 141 in combination with memory 142 to interact with a video messaging system, control media playback, select an electronic item, select at least one security option, and/or access stored data on one or more repositories maintained in the computing device 105. Additionally or alternatively, all processing capabilities may be performed at the central server system 115 via an associated processor 141 and database 142. For instance, the input received from a user 110, 130 via respective devices 105, 125 may be communicated to the central server system 115, which may include executable instructions to store, organize, transmit, present, or otherwise process the commands received from the respective devices 105, 125. Thus, when a user 110 sends a recipient 130 an electronic item/message, the message may be organized or relocated in the central server system 115 via the processor 141. Consequently, data usage by individual devices 105, 125 may be reduced thereby leading to longer battery life, faster processing rates and/or reduced expenditures, for example. The user interface 140 may include a microphone that enables the user to enter commands or other information vocally. The user interface 140 may additionally be configured to output alerts. For instance, the processor may communicate a push notification or alert to be displayed on the user interface 140 that an electronic item has been delivered or deleted from the at least one central server system 115 also including at least one processor 141 and a memory 142. Similarly, the user interface 140 may display a notification that a delivered item has been inappropriately saved, for example the computing device 125 took an unauthorized screen shot of the message.

In the illustrated example, computing device 105, acting as a sender device, relies on communication network 120 while computing device 125, acting as a recipient device, may also communicate with the central server system 115 via second communication network 135. Data may be transmitted between the devices 105, 125 and the central server system 115 using any number of wireless standards (e.g., IEEE 802.11, etc.) and/or cellular networks. Additionally or alternatively, the central server system 115 may include a messaging gateway to facilitate SMS and/or MMS traffic between the devices 105, 125 and the central server system 115. The central server system 115, via the gateway, may also support certain media communications and convert media files received via e-mail, for instance. That is, the central server system 115 may convert messages to the appropriate protocols to be understood by the devices 105, 125.

The communication network 120 as well as communication network 135 may include one or more networks, e.g., a telecommunications network maintained by a service provider or one or more public or private data networks. The communication networks 120 and 135 may also include a cellular network, Wi-Fi, Bluetooth®, any wireless communication network (e.g., high bandwidth GPRS/1XRTT channel, a wide area network (WAN) or local area network (LAN)), or any cloud-based communication. Thus, the network 120 and the network 135 may permit the exchange of communications between the computing devices 105, 125 by way of central server system 115. The networks 120, 135 may be unilateral (e.g., permitting communication from the computing device 105, 135 to the central server 115) or bilateral (e.g., permitting the free exchange of communication between the computing devices 105, 125 and the central server 115). While the first network 120 and second network 135 are shown as distinct networks, only one network may be used to facilitate communication between the devices 105, 125 and the central server system 115. Additionally or alternatively, if the networks 120, 135 are of differing protocols, a gateway may be in communication with both of the networks 120, 135 to facilitate interoperability between the networks 120, 135.

Computing device 105, acting as a sender device, may be operable to send messages to computing device 125, acting as a recipient device, via the central server system 115. The messages may include various forms of electronic communication such as electronic messaging (e-mail), Microsoft® Office documents, text messaging including Short Message Service (SMS) and Multimedia Messaging Service (MMS), voice messaging, etc. The central server system 115 may manage the incoming messages by storing, converting and delivering the messages to the intended recipient. According to one example, the system 100 may limit the size of the SMS communication to a predetermined number of characters (e.g., 500 characters). The system 100, via the central server system 115, may likewise permit MMS messaging to be communicated from the computing device 105 to the computing device 125. MMS is an extended version of the SMS, and allows for photographs and videos to be transmitted. An MMS message may be encoded at the computing device 105 before being transmitted. An MMS may be delivered using Hypertext Transfer Protocol (HTTP), for example.

Additionally or alternatively, the computing device 105 may be capable of communicating directly with the computing device 125 using near field communication (NFC) technologies. NFC may allow for short-range wireless communication between two devices. The computing device 105 may transmit data/messages to the computing device 125 using a Radio Frequency (RF) field created by the two devices when in close proximity to each other.

The user 110 via the computing device 105 may be capable of communicating the electronic items with associated security options. That is, the user 110 may set a “life span” for the content to be viewed. By setting a life span for the message duration (e.g., text messages, email, video, MP3, pictures, etc.), the user sets a limit to the period for which the message will be available on the central server system 115. When the period ends, the message will be deleted from the central server system 115 and from the computing device 125. Additionally or alternatively, the message may terminate upon activation by the computing device 125 via the destruction mechanism, e.g., the recipient views the message. The duration in which the computing device 125 may view the message may likewise include a predetermined period, for example 10 seconds.

The central server system 115 may include a processor 141, memory 142 and a database 150. The database may be integral to or separate from any specific computing device making up central server system 115. The processor 141 may be operable to interact with the database 150, and includes executable instructions to store and organize messages/information received from the computing device 105. The central server system 115 may be configured to provide certain communication capabilities to the computing device 105 and/or computing device 125. The central server system 115 may maintain information associated with subscribing users via the computing devices 105 or 125. For instance, the database 150 may maintain electronic items and associated security options corresponding with a specific cellular telephone number or mobile device number (MDN) unique to the computing devices 105 and 125. The central server system 115 may facilitate communication of the stored information/electronic items to a computing device 125 acting as a recipient device within the allotted retention time selected by the user 110 acting as a sender. However, upon expiration of the retention time or life span, the electronic items will be deleted from the central server system 115 and irretrievable by the recipient 130, regardless of whether or not the electronic item was accessed.

The central server system 115 may be operable to associate an electronic item and security option communicated by the computing device 105 via the processor 141. Further, the central server system 115 may recognize that an electronic item includes a “life-span,” which corresponds to a predefined period of time in which the user 110 acting as a sender selects for the central server system 115 to store the electronic item. The central server system 115 may store and continually update electronic items and security options in the database 150. For instance, the central server system 115 may periodically scan stored information to search for messages that have expired, e.g., due to expiration of the retention or “life-span”, the refraction mechanism feature, and/or expiration of the “time-bomb count-down.” Therefore, the sever 115 periodically “scrubs” the database 150 to erase expired electronic items, thereby reducing memory consumption.

According to one implementation, the processor 141 may interact with the database 150 to partition messages/information according to one or more partition protection techniques. For instance, the processor 141 may encrypt individual files/information associated with the computing device 105 to ensure the intended recipient(s) 130 are the only recipients able to access the information. Encryption generally transforms data in a reversible manner using an algorithm and an encryption key. Thus, only the intended recipients 130 may possess the encryption key in order to decrypt the data. The encryption of the data may be conducted by the central server system 115, given that it may possess significantly more processing power than the computing device 105. However, other exemplary approaches may include a computing device 105 with sufficient processing power to execute the encryption algorithm. Correspondingly, the encryption keys to decrypt the stored data may be maintained on the central server system 115; however, alternative approaches contemplate the encryption key being stored with the computing device 125.

The computing device 105 and central server system 115 may cooperate to determine if an unauthorized user, e.g., an intruder, is attempting to hack or otherwise illegitimately access electronic items. The central server system 115 may maintain a record of the date and time of intrusion, the code or password used to break into the computing device 105, the location of the intrusion (latitude and longitude), and, if applicable, current location of the intruder. For instance, if the intruder stole or found the user's device 105, the central server system 115 may determine the location of the intruder global positioning system that may be associated with computing device 105, for example. Additionally, the computing device 105 may have a set limit on wrong attempts to log in (e.g., wrongly entering password, PIN, or swipe pattern) until the computing device 105 automatically notifies the central server system 115 of a possible intrusion event.

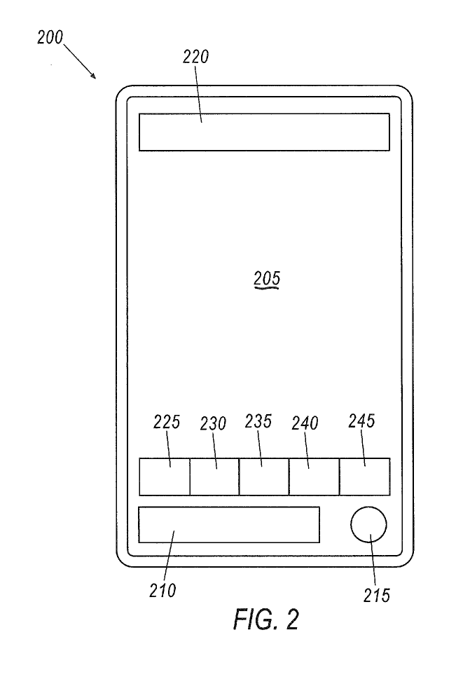

FIG. 2 illustrates an exemplary user interface 200 that may be used with one or both of the devices 105, 125. The user interface 200 may include touch or haptic sensors (not shown) configured to receive an input in a given position on the display 205 and associate the input with an electronic item selection. For instance, the user interface 200 may be responsive to haptic signals applied on the display 205, and in particular haptic signals applied to associated icons or controls. Thus, the processor may process haptic signals applied to an icon or control and execute computer-readable instructions to retrieve, store, organize, present and/or transmit features associated with the display icon/control (e.g., electronic items and/or security options).

The user interface 200 may include a plurality of dedicated controls configured to select various features via processor 141 in combination with memory 142. According to one exemplary implementation, the user interface 200 may include a touch-screen or display 205 configured to display icons or soft buttons corresponding to various electronic items presented for selection. For example, the user interface 200 may include a first control 210, second control 215, third control 220, fourth control 225, fifth control 230, sixth control 235, seventh control 240 and eighth control 245. Each control may execute a dedicated function, and include computer executable instructions to store, access, select and output at least one electronic item and/or at least one security option. For instance, fourth control 225 may correspond to an electronic item such as a photograph, and pressing on the fourth control 225 may enable a user to access an existing library or take a live action photograph.

As merely illustrative examples, the first control 210 may include a toggle button to minimize and expand controls 225-245, second control 215 may include a send command, third control 220 may be operable to select and add additional recipients, and controls 225-245 may include icons dedicated to various electronic item and security option selections. For instance, fourth control 225 may correspond to photograph and video messages, fifth control 230 may correspond to voice message, sixth control 235 may correspond e-mail, seventh control 240 may enable access to data maintained in the computing device 105 (e.g., internet access, historical photographs, Portable Document Format (PDF) files, Microsoft Office documents, MP3 files), and eighth control 245 may correspond to the security option feature. That is, pressing or otherwise activating the security option control 245 may prompt a selection of various security features which may be associated with a selected electronic item, for instance, the retaining period (e.g., “life-span”) in which the item will be maintained on the central server system 115 for a specified period of time (e.g., by way of a destruction mechanism) in which the electronic item will delete after being accessed by the recipient. Of course, it is contemplated that more or less controls may be employed, and that each control may perform one or more functions. For instance, the security option control 245 may include an intruder report and finder, which locates the position of an unauthorized user via GPS location systems, for example. Alternatively, the intruder feature may be a separate control accessible on the user interface 200.

Additionally, the user interface 200 may be operable to toggle through a plurality of “screens.” For instance, a user may be able to toggle through a home screen, a login screen, a contact screen, group screen, a settings page, an intruder report, etc. As an additional security mechanism, the user interface 200 may require a user to enter a customizable Personal Identification Number (PIN) or a security pattern shown on the display 205. An intruder report may be generated after a predetermined number of attempts to enter the password or PIN have failed. The report may be communicated to the central server system 115 and subsequently transmitted to the user's account.

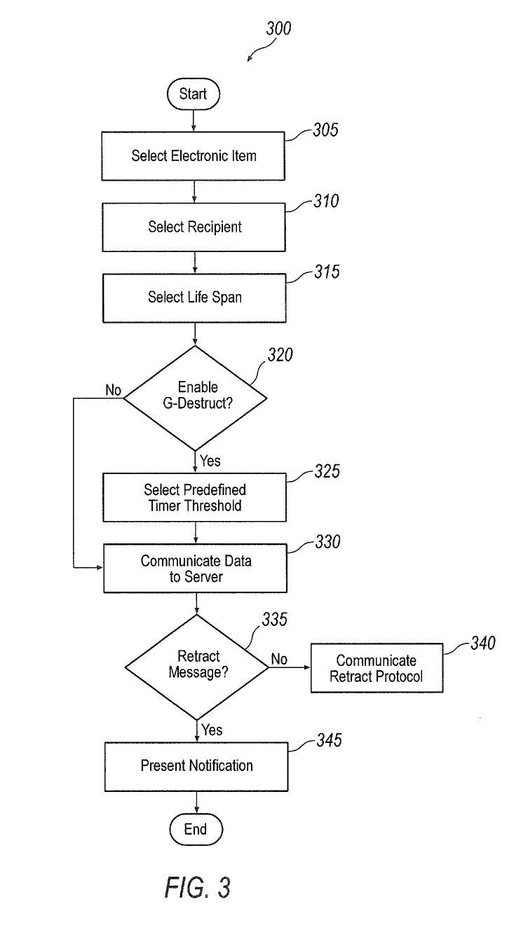

FIG. 3 is an exemplary process 300 of selecting an electronic item and/or a security option to be communicated to a recipient 130. The process 300 may be initiated when a user 110 opens or otherwise triggers the system 100. For example, the process 300 is initiated when a user 110 accesses an application presented on the user interface 200 of the computing device 105. The process 300 may begin at block 305. In block 305, an electronic item may be selected via activating a control on the user interface 200. That is, a user 110 may enter a command into the computing device 105 via the user interface 200. The electronic item may include, but is not limited to, SMS and MMS messages, photo and video messages (either live or historical), JPEG images, PDF, Microsoft® Office, MP3, QuickTime multimedia, e-mail, local data (e.g., information stored on a user's desktop or laptop), and internet links. Additionally, a user 110 may be able to purchase features via an application store, and send the feature (e.g., iTunes song, electronic gift card) as an electronic item. Accordingly, the variety of electronic items available for private and secure communication to intended recipients 130 is vast and unparalleled. The same or similar interface may be associated with computing device 125 and user 130 such as when computing device 125 becomes the sender device and computing device 105 becomes the recipient device.

In block 310, the user 110 selects intended recipients 130 for the electronic item. The user 110 may select any number of contacts that have accepted a request from the user. According to one example, contacts may only be linked together by request through phone number, user name, and/or email accounts. In this manner, subscribers to the system (e.g., users 110 and recipients 130) can remain anonymous unless the subscriber disseminated his/her contact information beforehand. Upon selecting the intended recipients 130, the user 110 may select a security option associated with the electronic item.

In block 315, the user 110 may select a “life span” of the communicated electronic item, or the period of time in which the central server system 115 will maintain the electronic item. That is, the user 110 may select any time from minutes to days—and even indefinitely—in which the central server system 115 will store the electronic item.

At block 320, the user 110 may determine if the electronic item will be associated with a “time-bomb count-down,” otherwise referred to as the destruction mechanism feature. If the user 110 so chooses, the message or electronic item will be accompanied with an associated predefined length of time in which the electronic item may be viewed upon opening the message. The “life span” refers to the duration of time in which the recipient 130 may access and view the message/electronic item, regardless whether the recipient decides to access the message or not. On the other hand, the destruction mechanism option triggers a timer once the recipient accesses the message. For instance, if a recipient 130 receives a photograph, the destruction mechanism timer initiates when the recipient opens the message for viewing, whereas the “life-span” begins as soon as the message is communicated to the central server system 115. However, both security options will destroy or delete the message after the threshold time has expired. If the user 110 does not wish to impose a viewing timer (e.g., G-Destruct feature), the process 300 proceeds to block 330. Otherwise, the process 300 proceeds to block 325.

In block 325, the user 110 may set the destruction mechanism timer via a dedicated control button of the user interface 200. The timer may include a variety of options, ranging from 1 second to 30 minutes, for example. As noted previously, the timer is triggered once the recipient 130 opens the message. Upon expiration of the timer, the electronic item/message is irretrievably deleted.

At block 330, the message—including the electronic item and associated security option—is communicated to the central server system 115. The central server system 115 may store the message in a database 150 for the selected life span, and facilitates communication of the message to the intended recipient(s) 130. Additionally, the message may be encrypted to ensure secure communication and storage of the electronic item.

At block 335, the user 110 may decide to retract or otherwise delete the message after the message has already been communicated to at least one of the central server system 115 and recipient 130. Selecting the retracting feature by way of a retraction mechanism instantly deletes messages on all devices associated with the message despite the time left on the message's life-span (e.g., designated retention time), and regardless of whether the recipient has viewed the message/electronic item. If the user 110 wants to retract the message, the process 300 proceeds to block 340. Otherwise, the process 300 proceeds to block 345.

At block 340, the computing device 105 transmits a refraction mechanism protocol to all recipient devices 125 and the central server system 115, instantly deleting the contents of the message such that the electronic item is permanently destroyed for viewing. The process 300 then proceeds to block 345, wherein the computing device 105 presents an alert, such as a push notification displayed on the user interface 140, that the message has been deleted.

If the user 110 has not initiated the retraction mechanism feature, the process 300 proceeds to block 345, and the computing device 105 may present an alert that the message has been successfully delivered, opened, and/or has expired. After block 345, the process ends.

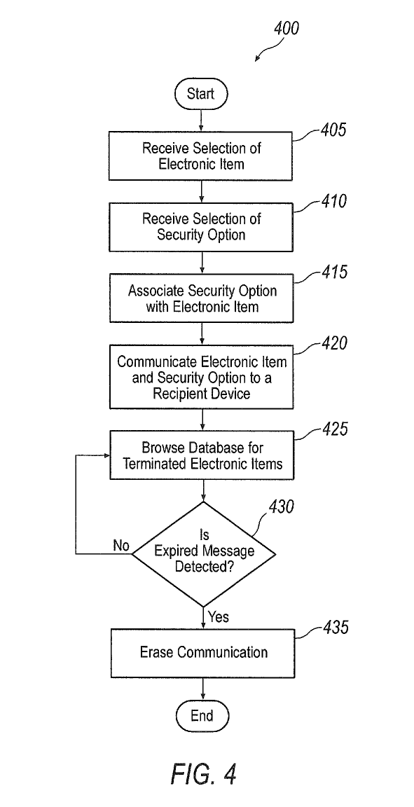

FIG. 4 is a flow chart illustrating the processing operation 400 associated with the communication system 100. The process operation 400 may be initiated at block 405 when central server system 115 receives a communication from a computing device 105 selecting an electronic item.

At block 410, the central server system 115 may likewise receive a security option selection, such as a defined retention time and/or destruction mechanism threshold indication from the computing device 105. The electronic item and security option may be communicated via the first communication network 120.

At block 415, the central server system 115 may be operable to associate the electronic item with the security option via the processor 141. The central server system 115 may compare the PIN number, phone number, HTTP, or other identifier unique to the computing device 105 to associate the correct electronic item with the corresponding security option. The central server system 115 may likewise store the message (e.g., electronic item and security option) in the database 150 for the duration of the retention time.

At block 420, the central server system 115 may facilitate communication of the message to the intended recipient(s) 130 via the second communication network 135. Before transmission, the central server system 115 may decrypt the message before communicating to the intended recipient 130. According to another example, the recipient 130 may decrypt the message locally via the computing device 125.

At block 425, the central server system 115 may scan or browse the database 150 periodically for detection of expired or deleted messages. The message may expire in response to various factors, include lapse of the life span, G-Destruct, and/or activating the G-Retract feature by the computing device 105. If an expired message is detected, the process 400 proceeds to block 435. Otherwise, the process 400 goes back to block 425 for the central server system 115 to scan the database 150 for expired messages.

At block 435, the central server system 115 permanently deletes the message from the database 150, such that the message can no longer be accessed or viewed by intended recipients 130. That is, the message is irreversibly corrupted and deleted from the computing device 125 and the central server system 115. After block 435, the process 400 ends.

Accordingly, the disclosed system 100 permits users 110, 130 to securely communicate (e.g., message and/or file share) each other between all manors of personal computing devices, such as a mobile device, personal computer, tablet, etc. The system 100 supports both Android and iOS platforms, and the types of files available for sharing include, but are not limited to, Microsoft® Office documents, PDFs, MP3, QuickTime Movie, Windows® Media, WAV files, Audio Interchange File Format (AIFFs). Furthermore, the system 100 enables fully secure internal messaging subscribing users 110, 130, and to send attachments with the same security features as described above.

Computing devices, such as devices 105, 125, the central server system 115, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

1. A system, comprising:
a computing device configured to:
receive a selection of an electronic item having at least one selected attribute;
receive a selection of a recipient correlating to the electronic item;
associate a retraction mechanism with the electronic item;
determine an availability threshold of the electronic item in response to at least one selected attribute; and
transmit the electronic item and the associated retraction mechanism to a recipient device associated with the recipient in response to staying within the availability threshold.

2. The system of claim 1, wherein the electronic item is at least one of an electronic text message, live photograph, historical photograph, data file, video, audio recording, MP3 and e-mail.

3. The system of claim 1, wherein the computing device is configured to retract the transmitted electronic item via the refraction mechanism in response to detecting the availability threshold has been reached.

4. The system of claim 1, wherein the attribute includes at least one of a defined duration of a retention mechanism and a defined duration of a destruction mechanism.

5. The system of claim 4, wherein the computing device is configured to:
determine an elapsed duration of the electronic item;
compare the elapsed duration with the availability threshold; and
corrupt the electronic item in response to detecting the elapsed duration exceeds the availability threshold making the electronic item unavailable to the recipient device.

6.-7. (canceled)

8. The system of claim 1, wherein the computing device is configured to receive a retraction command associated with the transmitted electronic item and recipient, and retract the transmitted electronic item from the recipient device in response to receiving the retraction mechanism making the electronic item unavailable to the recipient.

9. The system of claim 1, wherein the computing device is configured to:
identify an expired electronic item in response to detecting the electronic item has reached the availability threshold;
associate the expired electronic item with the transmitted electronic item and corresponding recipient device; and
retract the transmitted electronic item from the recipient device making the electronic item unavailable to the recipient.

10. The system of claim 1, wherein the computing device is configured to:
receive a selection of an accessibility option associated with the electronic item;
associate an interaction control with the electronic item based on the selected accessibility option, wherein the interaction control represents a limit on the recipient to interact with the electronic item; and
transmit the electronic item and interaction control to the recipient device.

11. The system of claim 1, wherein the computing device is configured to at least one of encrypt the electronic item to make unusable, and decrypt the encrypted electronic item to make the electronic item accessible to the recipient device.

12. A non-transitory computer readable medium tangibly embodying computer-executable instructions comprising instructions being executable by a processor of a computing device to provide operations comprising:
receiving a selection of an electronic item associated with at least one selected attribute;
receiving a selection of a recipient correlating to the electronic item;
associating a retraction mechanism with the electronic item;
determining an availability threshold of the electronic item based on the at least one selected attribute;
comparing the availability threshold with an elapsed tolerance corresponding to the electronic item; and
transmitting the electronic item and the associated retraction mechanism to a recipient device associated with the recipient if the elapsed tolerance does not exceed the availability threshold.

13. The medium of claim 12, further comprising retracting the transmitted electronic item from the recipient device via the retraction mechanism in response to detecting the elapsed tolerance exceeds the availability threshold making the electronic item unavailable to the recipient device.

14. The medium of claim 12, further comprising:
receiving a retraction command associated with the transmitted electronic item and recipient; and
retracting, via the retraction mechanism, the transmitted electronic item from the recipient device in response to receiving the retraction command making the electronic item unavailable to the recipient.

15. The medium of claim 14, further comprising updating a database in response to retracting the electronic item.

16. The medium of claim 12, further comprising:
receiving a selected accessibility option associated with the electronic item;
associating an interaction control with the electronic item in response to the selected accessibility option, wherein the interaction control represents a limit on the recipient to interact with the electronic item; and
transmitting the electronic item and interaction control to the recipient device.

17. The medium of claim 12, further comprising encrypting at least one of the electronic item and the recipient on a database, and presenting at least one of an unencrypted electronic item and an unencrypted recipient from the database for access by the recipient device.

18. The medium of claim 12, wherein the selected attribute include at least one of a retention duration and a destruction duration of the electronic item.

19. A method, comprising:
receiving, in a computing device having a processor and a memory, a selection of an electronic item;
receiving a selection of a recipient correlating to the electronic item;
associating a retraction mechanism with the electronic item;
determining an availability threshold of the electronic item in response to the associated retraction mechanism; and
transmitting the electronic item and the associated retraction mechanism to a recipient device associated with the recipient in response to staying within the availability threshold.

20. The method of claim 19, further comprising comparing the availability threshold of the electronic item with an elapsed tolerance, and retracting the electronic item in response to detecting the elapsed tolerance at least reaches the availability threshold making the electronic item unusable by the recipient device.

21. The method of claim 19, further comprising:
receiving a retraction command associated with the transmitted electronic item and recipient;
retracting the electronic item from the recipient device in response to receiving the retraction mechanism making the electronic item unavailable to the recipient device; and
at least one of (i) corrupting the electronic item to make the electronic item unusable and (ii) updating a database in response to retracting the electronic item from the recipient device.

22. The method of claim 19, further comprising:
receiving a selection of an accessibility option associated with the electronic item;
associating an interaction control with the electronic item based on the selected accessibility option, wherein the interaction control represents a limit on the recipient to interact with the electronic item; and
transmitting the electronic item and interaction control to the recipient device.
